(19) United States
(12) Patent Application Publication
(10) Pub. No.: US 2012/0130120 A1
(43) Pub. Date: May 24, 2012

(54) METHOD FOR THE MANUFACTURE OF PHOSPHONOALKYL IMINODIACETIC ACIDS

(75) Inventors: Patrick Notté, 1300 Wavre (BE); Cedric Nicolas Pirard, 4624 Romsee (Fleron) (BE); David Lemin, 1170 Watermael-Boitsfort (BE)

(73) Assignee: STRAITMARK HOLDING AG, 6300 Zug (CH)

(21) Appl. No.: 13/322,429

(22) PCT Filed: May 28, 2010
(86) PCT No.: PCT/EP10/57435

§ 371 Date: Feb. 8, 2012

(30) Foreign Application Priority Data
May 28, 2009 (EP) 09161401.6

(51) Int. Cl. C07F 9/38

(52) U.S. Cl. 562/17

(57) ABSTRACT

An improved method for the manufacture of phosphonoalkyl iminodiacetic acid (PAIDA) is disclosed. The iminodiacetic acid starting material is reacted with a considerable amount, in excess of stoichiometric requirements, of phosphorous acid to thereby yield a reaction medium insoluble reaction product which can be separated from the reaction medium. In a particularly preferred approach, the phosphorous acid is prepared in situ starting from liquid P₄O₆.

This invention pertains to a novel method for the manufacture of phosphonoalkyl iminodiacetic acid (PAIDA), in particular the phosphonomethyl imino diacetic acid (PMIDA) component, a major intermediate used in preparing glyphosate, also known as N-phosphonomethylglycine. In detail, the iminodiacetic acid (IDA) starting component is reacted with phosphorous acid, in excess of 100% to 600% expressed in relation to the stoichiometric level required for the synthesis of the phosphonomethyl imino diacetic acid compound, and formaldehyde. It was found that, within the context of the claimed technology, the reaction product, predominantly the phosphonoalkyl iminodiacetic acid, is substantially reaction medium insoluble and can be separated and recovered routinely. In a particularly preferred and major embodiment, the phosphorous acid reactant is prepared in situ by the hydrolysis of liquid P₄O₆ in the reaction medium.

The glyphosate chemistry, including the art relating to intermediates, methods of manufacture and so on, has been used commercially for a long time and is accordingly eminently well known in the relevant domain.

WO 00/59915 describes a process for preparing PMIDA by neutralising a salt solution of IDA with sulphuric or hydrochloric acid, separating the IDA component e.g by filtration and conversion of IDA with formaldehyde and phosphorous acid in the presence of sulphuric or hydrochloric acid to thus yield PMIDA and possibly recirculating the filtrate. WO 96/40698 teaches a method for preparing PMIDA starting from IDA, a source of formaldehyde, a source of phosphorous acid and a source of strong acid, usually hydrochloric acid. This art process requires the infusion of phosphorous acid and formaldehyde at levels such that the level of phosphorous acid in the reaction mixture is reduced which will lead to the formation of undesirable by-products. PCl₃ is generally employed as the source of strong acid. WO 94/15939 also concerns a process for the manufacture of PMIDA starting from IDA with phosphorous acid and formaldehyde in aqueous medium in the presence of concentrated sulphuric acid. PMIDA precipitates and can be filtered and the filtrate can be recirculated to the reaction medium.

U.S. Pat. No. 6,232,494 concerns an improved process for the manufacture of glyphosate including a recitation of leading PMIDA making methods and inherent difficulties such as dealing with hindering sodium chloride levels and also a summary listing of difficulties to be overcome in converting PMIDA to glyphosate. The removal of chloride from PMIDA is also described in US 2002/0148786; the use of evaporative crystallisation constitutes a contemplated approach. U.S. Pat. No. 4,775,498 explains a method for the manufacture of N,N-diacetic acid aminoalkylene phosphonic acid (PAIDA) by addition of phosphorous trichloride to water and IDA, adding formaldehyde and water to dissolve alkali metal salt, followed by adjusting the pH and filtering the PMIDA precipitate. EP 0 595 598 illustrates a process for preparing PMIDA whereby IDA is first reacted with formaldehyde to yield HMIDA which component is subsequently reacted with phosphorous acid and so converted to PMIDA.

EP 0 679 158 describes a process for preparing PMIDA by reacting IDA with phosphorous acid and formaldehyde in the presence of concentrated sulphuric or hydrochloric acid and recovering the PMIDA precipitate. EP 0 618 212 similarly describes a process for preparing PMIDA by reacting IDA with formaldehyde and an aqueous solution of phosphorous acid and hydrochloric acid, resulting from the phosphorous trichloride hydrolysis. The PMIDA can then be recovered from the reaction product. GB 2 154 589 concerns an energy economic arrangement for preparing PMIDA starting from IDA species, sulfuric acid and hydrochloric acid. CN 101348266 relates to the treatment of the NaCl containing PMIDA mother liquid to thus recover the PMIDA and utilize the NaCl by-product. CN 101307074 pertains to a method for preparing PMIDA and chloroalkane and acetal by-products. CN 101284847 describes the making of PMIDA by reacting IDA Na salts with sulphuric acid at pH 5-8 and mixing the IDA so formed with phosphorous acid and formaldehyde to thus yield PMIDA. EP 08155198.8 describes a process for the manufacture of amino alkylene phosphonic acids starting from P₄O₆ in the presence of a homogeneous Broensted catalyst. The method can be used for the preparation of PMIDA.

The prior art abundantly illustrates the significant difficulties and shortcomings attached to the use of known PMIDA manufacturing technologies. Major difficulties can reside in the selection of the acid catalyst, usually sulphuric and/or hydrochloric acid, the presence of chlorides, frequently alkali chlorides, the formation of undesirable levels of by-products and the lack of selectivity of the reaction product. In addition, PMIDA produced in accordance with art technologies, requires special precautions in the conversion to glyphosate while the corrosive nature of chloride ions can adversely affect equipment economics.

While considerable moneys had been spent for the purpose of alleviating quality and/or economic aspects of the manufacturing technology, marginal solutions directed to specific shortcomings had, at best, been elaborated.

It is an aim of this invention to make available a manufacturing arrangement which does not require the use of a concentrated acid, such as hydrochloric acid or any concentrated acid different from the reactants and requiring on-purpose purification of the end product. Still another object of the invention aims at providing the end product in a reactant uniform medium i.e. under exclusion of reactants which can require an on-purpose separation from the mother liquid containing the end product. Still another object pertains at avoiding using corrosive reactants. Another major object of the invention contemplates synthesizing the end product, routinely recoverable, and recycling the mother liquid, without any further treatment into the reaction. It is a major object of this invention to provide a PMIDA manufacturing method which is not affected by the cumulative art shortcomings and which can yield a high purity product.

The term “percent” or “%” as used throughout this application stands, unless defined differently, for “percent by weight” or “% by weight”. The terms “phosphonic acid” and “phosphonate” are also used interchangeably depending, of course, upon medium prevailing alkalinity/acidity conditions. The term “ppm” stands for “parts per million”. The terms “P₂O₃” and “P₄O₆” can be used interchangeably. Unless defined differently, pH values are measured at 25° C. on the reaction medium as such. The designation “phosphorous acid” means phosphorous acid as such, phosphorous acid prepared in situ starting from P₄O₆ or purified phosphorous acid starting from PCI₃ or purified phosphorous acid resulting from the reaction of PCl₃ with carboxylic acid, sulfonic acid or alcohol to make the corresponding chloride. The term mother liquid designates the continuous liquid phase of the reaction medium, especially after the removal of the solid PAIDA material. The term “liquid P₄O₆” embraces neat P₄O₆ in the liquid state, solid P₄O₆ and gaseous P₄O₆. The term “ambient” with respect to temperature and pressure means terrestrial conditions usually prevailing at sea level, i.e., temperature is about 18° C.-25 ° C. and pressure stands for 990-1050 mm Hg. The term “insoluble in the reaction medium” defines the solubility of the reaction product, at the end of the reaction, in gram/100 grams of the reaction medium.

The above and other objects can now be attained by means of a method arrangement whereby an imino diacetic acid is reacted with a considerable amount, in excess of stoichiometric requirements, of phosphorous acid. In more detail, this invention pertains to a method for the manufacture of phosphonoalkyl imino diacetic acid having the formula:

M₂PO_{3—X—N—(CH}₂COOM)₂

wherein X is a C₁₋₆ linear or branched alkyl hydrocarbon group; and M is selected from hydrogen, alkali, earth-alkali, ammonium and protonated amine; by:

a) reacting imino diacetic acid with phosphorous acid, in excess of 100% to 600% expressed in relation to the stoichiometric level required for the formation of the phosphonoalkyl product to be synthesized, and a formaldehyde at a temperature in the range of from 45° C. to 200° C. for a period of from 1 minute to 10 hours, to thereby yield a reaction product, which is substantially insoluble in the reaction medium; and

b) separating the insoluble reaction product.

In a) the formaldehyde and the iminodiacetic acid are preferably are reacted in a molar ratio of formaldehyde:iminodiacetic acid of from 2:1 to 0.5:1.

The insoluble reaction product can be water washed after the separation from the reaction medium.

In a preferred execution herein, the alkylene group X is methylene and the end product, PMIDA, can easily be converted to glyphosate, a well known herbicide commercialized for already several decades.

The reaction product, PMIDA, is substantially insoluble in the reaction medium. The reaction product can have a solubility, measured at ambient temperature, of equal to or less than 10 g/100 g of reaction medium. The solubility can be determined at the pH of the mother liquor, inferior to 2, preferably inferior to 1.

In another preferred embodiment herein, the phosphorous acid is prepared in situ starting from liquid, P₄O₆.

It is understood that the claimed technology is particularly beneficial in that the reaction medium is uniform and that the reaction partners are identical to the constituents of the products to be manufactured i.e. the system operates under exclusion of system-foreign components with its obviously significant benefits. This includes, inter alia, the fact that after the separation of the reaction product, the remaining part of the reaction medium, i.e. the mother liquid, can generally be recycled easily. In some cases the insolubility of the reaction product can be enhanced by adding water and/or a water-soluble organic diluent. So proceeding requires routine measures well known in the domain of separation technology. Examples of suitable organic solvents include alcohols e.g. ethanol and methanol. The levels of the precipitation additives e.g. water/alcohol to be used vary based on the reaction medium and can be determined routinely. It goes without saying that the organic solvents shall be removed, e.g. by distillation, before the mother liquid is recycled.

The insoluble amino alkylene phosphonic acid reaction product can be separated from the liquid phase, e.g. for recovery purposes, by physical means known in the art e.g. by settling, filtration or expression. Examples of the like processes include gravity settling sometimes through exercising centrifugal force e.g. in cyclones; screen, vacuum or centrifugal filtration; and expression using batch or continuous presses e.g. screw presses.

The phosphorous acid reactant is a commodity material well known in the domain of the technology. It can be prepared, for example, by various technologies some of which are well known, including hydrolysing phosphorus trichloride or P-oxides. Phosphorous acid and the corresponding P-oxides can be derived from any suitable precursor including naturally occurring phosphorus containing rocks which can be converted, in a known manner, to elemental phosphorus followed by oxidation to P-oxides and possibly phosphorous acid. The phosphorous acid reactant can also be prepared, starting from hydrolyzing PCl₃ and purifying the phosphorous acid so obtained by eliminating hydrochloric acid and other chloride intermediates originating from the hydrolysis. In another approach, phosphorous acid can be manufactured beneficially by reacting phosphorus trichloride with a reagent which is either a carboxylic acid or a sulfonic acid or an alcohol. The PCl₃ reacts with the reagent under formation of phosphorous acid and an acid chloride in the case of an acid reagent or a chloride, for example an alkylchloride, originating from the reaction of the PCl₃ with the corresponding alcohol. The chlorine containing products, e.g. the alkylchloride and/or the acid chloride, can be conveniently separated from the phosphorous acid by methods known in the art e.g. by distillation. While the phosphorous acid so manufactured can be used as such in the claimed arrangement, it can be desirable and it is frequently preferred to purify the phosphorous acid formed by substantially eliminating or diminishing the levels of chlorine containing products and non-reacted raw materials. Such purifications are well known and fairly standard in the domain of the relevant manufacturing technology. Suitable examples of such technologies include the selective adsorption of the organic impurities on activated carbon or the use of aqueous phase separation for the isolation of the phosphorous acid component. Information pertinent to the reaction of phosphorous trichloride with a reagent such as a carboxylic acid or an alcohol can be found in Kirk-Othmer, Encyclopedia of Chemical Technology, in chapter Phosphorous Compounds, Dec. 4, 2000, John Wiley & Sons Inc.

In a preferred execution herein, the phosphorous acid reactant can be prepared by adding P₄O₆ to the reaction medium. The reaction medium can possibly contain the IDA reactant, or the IDA reactant can be added simultaneously with the P₄O₆ The IDA reactant can also be added to the reaction medium after the hydrolysis of the P₄O₆ has been completed before the formaldehyde addition. In any case, the balance of the phosphorous acid is added before addition of the formaldehyde component. The simultaneous addition of the IDA and the P₄O₆ shall preferably be effected in parallel i.e. a premixing, before adding to the reaction medium, of the IDA and the P₄O₆ shall for obvious reasons be avoided. The phosphorous acid shall be used in an excess of from 100% to 600%, preferably from 100% to 500%, in particular from 200% to 400%. The excess of phosphorous acid is calculated by multiplying the number of mole(s) of IDA being reacted by 1 to 6 to thus quantify the number of moles of excess phosphorous acid to be used. The phosphorous acid actually enhances the reaction without requiring any measure except the recirculation of the phosphorous acid containing mother liquid, as a homogeneous reactant, to the reaction medium. The absence of any products foreign to the composition of the phosphonic acids to be synthesized constitutes a considerable step forward in the domain of the technology on account of purification and separation methods currently required in the application of the art technology.

The starting components, i.e. phosphorous acid, IDA and formaldehyde component, shall be used in levels commensurate with the stoichiometric requirements of the end product, PAIDA, generally in a molar ratio of 1:1:1 with the understanding that these levels can vary over a range of from ±20%. The phosphorous acid, so quantified, relates to the stoichiometric needs and does not account for the excess phosphorous acid which can routinely be determined as referred to above. The formaldehyde is usually used in the method of this invention in a molar ratio of formaldehyde:iminodiacetic acid of from 2:1 to 0.5:1; preferably from 1.5:1 to 0.7:1, in particular from 1.2:1 to 0.9:1. The use of relatively minor ratios of formaldehyde were found to be beneficial for optimizing selectivity while the non-reacted part of the raw material (mother liquid) can be recycled conveniently.

The P₄O₆ can be represented by a substantially pure compound containing at least 85%, preferably more than 90%; more preferably at least 95% and in one particular execution at least 97% of the P₄O₆. While tetraphosphorus hexa oxide, suitable for use within the context of this invention, can be manufactured by any known technology, in preferred executions the hexa oxide can be prepared in accordance with the process disclosed in WO 2009/068636 entitled “Process for the manufacture of P₄O₆” and/or WO 2010/055056, entitled “Process for the manufacture of P₄O₆ with improved yield”. In detail, oxygen, or a mixture of oxygen and inert gas, and gaseous or liquid phosphorus are reacted in essentially stoichiometric amounts in a reaction unit at a temperature in the range from 1600 to 2000° K, by removing the heat created by the exothermic reaction of phosphorus and oxygen, while maintaining a preferred residence time of from 0.5 to 60 seconds followed by quenching the reaction product at a temperature below 700° K and refining the crude reaction product by distillation. The hexa oxide so prepared is a pure product containing usually at least 97% of the oxide. The P₄O₆ so produced is generally represented by a liquid material of high purity containing in particular low levels of elementary phosphorus, P₄, preferably below 1000 ppm, expressed in relation to the P₄O₆ being 100%. The preferred residence time is from 5 to 30 seconds, more preferably from 8 to 30 seconds. The reaction product can, in one preferred execution, be quenched to a temperature below 350° K.

The term “liquid P₄O₆” embraces, as spelled out, any state of the P₄O₆. However, it is presumed that the P₄O₆ participating in a reaction at a temperature of from 45° C. to 200° C. is necessarily liquid or gaseous although solid species can, academically speaking, be used in the preparation of the reaction medium.

The P₄O₆ (mp. 23.8° C.; bp. 173° C.), preferably in liquid form, is added to the aqueous reaction medium containing:

at least part of the phosphorous acid sufficient to maintain the pH at all times below 5, preferably below 3, in particular equal to or smaller than 2 to thus complete the addition/hydrolysis of the P₄O₆ followed by the addition of the IDA; or

part of the phosphorous acid sufficient to maintain the pH at all times below 5, preferably below 3, in particular equal to or smaller than 2 and the IDA; or

add the P₄O₆ and the IDA simultaneously to the reaction medium.

This reaction medium thus contains the P₄O₆ hydrolysate and the IDA, possibly as a salt. The hydrolysis is conducted at ambient temperature conditions 20° C. up to about 150° C. While higher temperatures e.g. up to 200° C., or even higher, can be used such temperatures generally require the use of an autoclave or can be conducted in a continuous manner, possibly under autogeneous pressure built up. The temperature increase during the P₄O₆ addition can result from the exothermic hydrolysis reaction and was found to provide temperature conditions to the reaction mixture as can be required for the reaction with formaldehyde. In the event the P₄O₆ hydrolysis is conducted in the presence of the amine, i.e. the amine is present in the reaction medium before adding the P₄O₆ or the amine is added simultaneously with the P₄O₆.

The essential formaldehyde component is a well known commodity ingredient. Formaldehyde sensu stricto known as oxymethylene having the formula CH₂O is produced and sold as water solutions containing variable, frequently minor, e.g. 0.3-3%, amounts of methanol and are typically reported on a 37 formaldehyde basis although different concentrations can be used. Formaldehyde solutions exist as a mixture of oligomers. Such formaldehyde precursors can, for example, be represented by paraformaldehyde, a solid mixture of linear poly(oxymethylene glycols) of usually fairly short, n=8-100, chain length, and cyclic trimers and tetramers of formaldehyde designated by the terms trioxane and tetraoxane respectively.

The formaldehyde component can also be represented by aldehydes and ketones having the formula R₁R₂C=O wherein R₁ and R₂ can be identical or different and are selected from the group of hydrogen and organic radicals. When R₁ is hydrogen, the material is an aldehyde. When both R₁ and R₂ are organic radicals, the material is a ketone. Species of useful aldehydes are, in addition to formaldehyde, acetaldehyde, caproaldehyde, and crotonaldehyde, Suitable ketone species for use herein are acetone, methylethylketone, 2-pentanone, and butyrone.

The P₄O₆ (mp. 23.8° C.; bp. 173° C.) in liquid form is added to the aqueous reaction medium having a pH at all times below 5. The P₄O₆ is added to the reaction mixture under stirring generally starting at ambient temperature. The reaction medium can contain the amine although the amine can also be added simultaneously with the P₄O₆ or after the addition (hydrolysis) of the P₄O₆ has been completed, whereby the pH of the reaction medium is also maintained, at all times, below 5, preferably below 3, most preferably equal to or below 2.

The reaction in accordance with this invention is conducted in a manner routinely known in the domain of the technology. As illustrated in the experimental showings, the method can be conducted by combining the essential reaction partners and heating the reaction mixture to a temperature usually within the range of from 45° C. to 200° C., and higher temperatures if elevated pressures are used, more preferably 70° C. to 150° C. The upper temperature limit actually aims at preventing any substantially undue thermal decomposition of the phosphorous acid reactant. It is understood and well known that the decomposition temperature of the phosphorous acid, and more in general of any other individual reaction partners, can vary depending upon additional physical parameters, such as pressure and the qualitative and quantitative parameters of the ingredients in the reaction mixture.

The inventive method can be conducted under substantial exclusion of added water beyond the stoichiometric level required for the hydrolysis of the P₄O₆. However, it is understood that the reaction in accordance with the inventive method i.e. the formation of N-C-P bonds will generate water. After the P₄O₆ hydrolysis has been completed, the amount of residual water is such that the weight of water is from 0% to 60% expressed in relation to the weight of iminodiacetic acid, calculated before the addition of the formaldehyde addition.

The inventive reaction can be conducted at ambient pressure and, depending upon the reaction temperature, under distillation of water, thereby also eliminating a minimal amount of non-reacted formaldehyde component. The duration of the reaction can vary from virtually instantaneous, e.g. 1 minute, to an extended period of e.g. 10 hours. This duration generally includes the gradual addition, during the reaction, of the formaldehyde component and possibly other reactants. In one method set up, the phosphorous acid reagent and the amine are added to the reactor followed by heating this mixture under gradual addition of the formaldehyde component starting at a temperature e.g. in the range of from 45° C. to 150° C. This reaction can be carried out under ambient pressure with or without distillation of usually water and some non-reacted formaldehyde.

In another operational arrangement, the reaction can be conducted in a closed vessel under autogeneous pressure built up. In this method, the reaction partners, in total or in part, are added to the reaction vessel at the start. In the event of a partial mixture, the additional reaction partner can be gradually added, alone or with any one or more of the other partners, as soon as the effective reaction temperature has been reached. The formaldehyde component can, for example, be added gradually during the reaction alone or with parts of the IDA or the phosphorous acid.

In yet another operational sequence, the reaction can be conducted in a combined distillation and pressure arrangement. Specifically, the reaction vessel containing the reactant mixture is kept under ambient pressure at the selected reaction temperature. The mixture is then, possibly continuously, circulated through a reactor operated under autogeneous (autoclave principle) pressure built up thereby gradually adding the formaldehyde or additional reaction partners in accordance with needs. The reaction is substantially completed under pressure and the reaction mixture then leaves the closed vessel and is recirculated into the reactor where distillation of water and other non-reacted ingredients can occur depending upon the reaction variables, particularly the temperature.

The foregoing process variables thus show that the reaction can be conducted by a variety of substantially complementary arrangements. The reaction can thus be conducted as a batch process by heating the initial reactants, usually the phosphorous acid, and the IDA in a (1) closed vessel under autogeneous pressure built up, or (2) under reflux conditions, or (3) under distillation of water and minimal amounts of non-reacted formaldehyde component, to a temperature preferably in the range of from 70° C. to 150° C. whereby the formaldehyde component is added, as illustrated in the Example, gradually during the reaction. In a particularly preferred embodiment, the reaction is conducted in a closed vessel at a temperature in the range of from 100° C. to 150° C., coinciding particularly with the gradual addition of formaldehyde, within a time duration of from 1 minute to 30 minutes, in a more preferred execution from 1 minute to 10 minutes.

In another approach, the reaction is conducted as a continuous process, possibly under autogeneous pressure, whereby the reactants are continously injected into the reaction mixture, at a temperature preferably in the range of from 70° C. to 150° C. and the phosphonic acid reaction product is withdrawn on a continuous basis.

In yet another arrangement, the method can be represented by a semi-continuous set-up whereby the phosphonic acid reaction is conducted continuously whereas preliminary reactions between part of the components can be conducted batch-wise.

The reaction product can subsequently, and in accordance with needs, be neutralized, in part or in total, with ammonia, amines, alkali hydroxides, earth-alkali hydroxides or mixtures thereof

Phosphonomethyl iminodiacetic acids prepared by the method of the invention are useful intermediates for manufacturing the herbicide glyphosate ((HO)₂PO—CH₂—NH—CH₂—OOOH). Possible manufacturing routes are disclosed, e.g. in U.S. Pat. No. 6,232,494.

Accordingly, in a further aspect of the invention there is provided a method for manufacturing glyphosate or a salt thereof comprising the step of converting a phosphonomethyl iminodiacetic acid, obtained by the process of the invention, by oxidative cleavage of one CH₂—COOM-group to yield glyphosate or a salt thereof.

The invention is further illustrated by the following examples without limiting it thereby.

### Examples

1. In a three-necked round-bottom flask equipped with a mechanical stirrer and a Dean-Stark tube, 66.56 g (0.5 mol) of iminodiacetic acid (IDA) were mixed with 164 g (2 mol, 4 eq.) of phosphorous acid and 70 mL of water. The reaction mixture was heated to reflux and water was distilled through the Dean-Stark tube until the temperature of the reaction mixture reached 136° C. 43.2 mL of a 36.6 wt.-% aqueous solution of formaldehyde (1.15 eq.) were then added over 70 min. During the addition 53 mL water were removed from the reaction mixture through the Dean-Stark tube, keeping the temperature of the reaction mixture between 130 and 136° C. During the addition a precipitate was formed. After completion of the formaldehyde addition the reaction mixture was kept under reflux for 35 minutes. The precipitate was isolated from the cooled reaction mixture by filtration and washed with fresh water. The dried precipitate was analysed by ¹H and ³¹P NMR and identified as 99% pure N-(phosphonomethyl) iminodiacetic acid (PMIDA, 76.4 g, 67.3% yield).

2. In a three-necked round-bottom flask equipped with a mechanical stirrer and a Dean-Stark tube, 33.96 g (0.25 mol.) of iminodiacetic acid (IDA) were mixed with 143.5 g (1.75 mol.) of phosphorous acid and 13.6 g of water. The reaction mixture was heated to 140° C. 18.80 mL of a 36.6 wt.-% aqueous solution of formaldehyde (0.25 mol.) were then added over 118 min. The reaction temperature has been maintained between 125 and 140° C. during formaldehyde addition. The precipitate was isolated from the cooled reaction mixture by filtration and washed with fresh water. The dried precipitate was analysed by ¹H and ³¹P NMR and identified as 91.3% pure N-(phosphonomethyl) iminodiacetic acid (PMIDA, 42 g, 74 % yield based on iminodiacetic acid).

3. In a three-necked round-bottom flask equipped with a mechanical stirrer and a Dean-Stark tube, 67.91 g (0.50 mol) of iminodiacetic acid (IDA) were mixed with 165.64 g (2 mol; 99% pure.) of phosphorous acid and 34 ml of water. The reaction mixture was heated to reflux and 7 ml of water were distilled through the Dean-Stark tube until the temperature of the reaction mixture reached 140° C. 41.36 mL of a 36.6 wt.-% aqueous solution of formaldehyde (0.55 mol.) were then added over 60 min. The reaction temperature has been maintained between 117 and 140° C. during formaldehyde addition. After completion of the formaldehyde addition the reaction mixture was kept under reflux for 30 minutes. The precipitate was isolated from the cooled reaction mixture by filtration and washed with fresh water. The dried precipitate was analysed by ¹H and ³¹P NMR and identified as 94.0% pure N-(phosphonomethyl) iminodiacetic acid (PMIDA, 69.2 g, 60.9% yield based on iminodiacetic acid).

4. In a three-necked round-bottom flask equipped with a mechanical stirrer and a Dean-Stark tube, 67.91 g (0.5 mol.) of iminodiacetic acid (IDA) were mixed with 165.64 g (2 mol.; 99% pure.) of phosphorous acid and 25 ml of water. The reaction mixture was heated to reflux and water was distilled through the Dean-Stark tube until the temperature of the reaction mixture reached 140° C. 39.48 mL of a 36.6 wt.-% aqueous solution of formaldehyde (0.525 mol.) were then added over 60 min. The reaction temperature has been maintained between 120 and 140° C. during formaldehyde addition. After completion of the formaldehyde addition the reaction mixture was kept under reflux for 30 minutes. The precipitate was isolated from the cooled reaction mixture by filtration and washed with fresh water. The dried precipitate was analysed by ¹H and ³¹P NMR and identified as 96.3% pure N-(phosphonomethyl) iminodiacetic acid (PMIDA, 67.1 g, 59.1% yield based on iminodiacetic acid).

5. In a three-necked round-bottom flask equipped with a mechanical stirrer and a Dean-Stark tube, 33.96 g (0.25 mol.) of iminodiacetic acid (IDA) were mixed with 143.5 g (1.75 mol.) of phosphorous acid and 13.6 g of water. The reaction mixture was heated to reflux and water was distilled through the

Dean-Stark tube until the temperature of the reaction mixture reached 130° C. 20.68 mL of a 36.6 wt.-% aqueous solution of formaldehyde (0.275 mol.) were then added over 130 min. The reaction temperature has been maintained between 130 and 132° C. during formaldehyde addition and 11 ml of water were distilled during this addition. The precipitate was isolated from the cooled reaction mixture by filtration and washed with fresh water. The dried precipitate was analysed by ¹H and ³¹P NMR and identified as 92.5% pure N-(phosphonomethyl) iminodiacetic acid (PMIDA, 51.8 g, 91.3% yield based on iminodiacetic acid).

1. A method for the manufacture of a phosphonoalkyl imino diacetic acid having the formula:
M₂PO₃—X—N—(CH₂COOM)₂
wherein X is —CH₂—; and M is selected from hydrogen, alkali, earthalkali, ammonium and protonated amine; by:
a) reacting imino diacetic acid with phosphorous acid, said phosphorous acid being in excess of 100% to 600% expressed in relation to the stoichiometric level required for the formation of the phosphonoalkyl product to be synthesized, and formaldehyde in a molar ratio formaldehyde : iminodiacetic acid of from 2:1 to 0.5:1, at a temperature in the range of from 45° C. to 200° C. for a period of from 1 minute to 10 hours, to thereby yield a reaction product,
which is substantially insoluble in the reaction medium, and
b) separating the insoluble reaction product from the mother liquid.

2. The method in accordance with claim 1 wherein the excess phosphorous acid is from 100% to 400%.

3. The method in accordance with claim 1, wherein the mother liquid is, after the separation of the reaction product, recycled into the reaction medium.

4. The method in accordance with claim 1, wherein the reaction is carried out at a temperature in the range of from 70° C. to 150° C. combined with an approach selected from:
conducting the reaction under ambient pressure with or without distillation of water and non-reacted formaldehyde;
in a closed vessel under autogeneous pressure built up;
in a combined distillation and pressure arrangement whereby the reaction vessel containing the reactant mixture is kept under ambient pressure at the reaction temperature followed by circulating the reaction mixture through a reactor operated under autogeneous pressure built up thereby gradually adding the formaldehyde and other selected reactants in accordance with needs; and
a continuous process arrangement, in one approach under autogeneous pressure built up, whereby the reactants are continuously injected into the reaction mixture and the phosphonic acid reaction product is withdrawn on a continuous basis.

5. The method in accordance with claim 1, wherein the reaction is conducted at a temperature in the range of from 115° C. to 145° C.

6. The method in accordance with claim 1, wherein the phosphorous acid used is prepared from phosphorus trichloride, and contains not more than 1000 ppm of chlorhydric acid, expressed in relation to the phosphorous acid (100%).

7. The method in accordance with claim 6, wherein the phosphonoalkyl imino diacetic acid reaction product contains less than 400 ppm of chlorine expressed in relation to the iminodiacetic acid (100%).

8. The method in accordance with claim 1, wherein the phosphorous acid is prepared in situ by adding liquid P₄O₆ to an aqueous reaction medium containing phosphorous acid in a level to maintain the pH in the reaction medium at all times below 5, whereby the reaction medium can contain in addition to the water and the phosphorous acid:
(a) the imino diacetic acid component; or
(b) whereby the imino diacetic acid is added to the reaction medium simultaneously with the P₄O₆; or
(c) wherein the imino diacetic acid is added to the reaction medium after the addition/hydrolysis of the P₄O₆ has been completed.

9. The method in accordance with claim 8, wherein the P₄O₆ is manufactured by reacting oxygen and phosphorus in stoichiometric amounts in a reaction unit at a temperature in the range of from 1600 to 2000° K with a reaction residence time from 0.5 to 30 seconds, followed by quenching the reaction product at a temperature below 700 20 K and refining the reaction product by distillation.

10. The method in accordance with claim 9, wherein the level of elementary phosphorus in the P₄O₆ is below 1000 ppm, expressed in relation to P₄O₆ (100%).

11. The method in accordance with claim 3, further comprising the step of converting the obtained phosphonomethyl iminodiacetic acid to glyphosate or a salt thereof by oxidative cleavage of one CH₂—COOM group.
